(19) United States
(12) Patent Application Publication
(10) Pub. No.: US 2011/0253579 A1
(43) Pub. Date: Oct. 20, 2011

(54) PRODUCT AND PACKAGE FASTENING APPARATUS AND METHOD

(76) Inventors: Hiu Man Chong, Tsim Sha Tsui (HK); Wan Lung Cheung, Fanling (HK)

(21) Appl. No.: 12/759,865

(22) Filed: Apr. 14, 2010

(51) Int. Cl. B65D 73/00; B23P 11/00

(52) U.S. Cl. 206/493; 29/525.01

(57) ABSTRACT

An apparatus for fastening a product to its package for shipment and display. The apparatus includes a key having a base, an inner pad and outer ring portions. The base includes two bridges supporting two pairs of living hinges, each of the pairs being connected to an outer ring portion. The outer ring portions are enabled to pivot between a position generally aligned with the inner pad and a position generally perpendicular to the inner pad so as to act as a handle to rotate the key. The inner pad supports a post and a pair of protrusions. Between the inner pad and the outer ring portions are openings for receiving a strip of stiff paper. After the key is inserted through the package and into the product, the key is rotated to cause an abutment of the protrusions with the product to fasten the product and package together. The strip is then inserted to prevent inadvertent rotation of the key. After purchase, a consumer may easily and quickly remove the strip, rotate the key and remove it from the product and the package to enable the product to be separated from the package, and the package and the key to be disposed. Multiple keys are used with multiple strips incorporated in a stiff paper panel. Each strip takes the form of a hole in the panel flanked by two strip tabs that connect to the key inserted through the hole of the strip. A reinforcing support may be placed between the panel and the package.

### FIELD OF THE INVENTION

The present invention relates generally to a fastening apparatus, and more particularly, to a fastening apparatus for easily connecting a product to its package at a point of assembly and thereafter, maintaining the connection of the product and package combination during shipment of the combination and while the product is displayed at retail. After the product is purchased, a consumer is able to easily unfasten the apparatus to disconnect and separate the product from its package.

### BACKGROUND OF THE INVENTION

Smaller products, and especially toy products, are typically packaged at a factory or an assembly location, and they are then shipped and displayed at retail in the original package or container. After the product is purchased and taken home, the product is removed from its package, and the package is usually discarded. For some small products blister card packaging is often used. The blister card package includes a stiff card usually printed with attractive or eye catching designs. A product fitting, clear plastic covering is secured to the card to capture the product in a predetermined position. The card and covering are designed to be hung from shelf hangers or to be stood directly on shelves. More recent packages also include cards but may have a non-form fitting clear plastic containers that are generally larger than the products.

Various techniques are used to secure the product within the container. For example, an interior stiff material platform, such as one made of corrugated, may be used and the product is connected to the platform and perhaps to a card by tie-down wires, also called twist ties. A major drawback to the use of twist ties is that they are usually taped over, and consumers find them difficult to remove without one or more tools.

In general, product retention devices are well represented in earlier patents. For example, in 1980, U.S. Pat. No. 4,185,739, listing Wilford as the inventor, issued for an invention entitled, “Retention of Articles On A Sheet” and purports to disclose a device for retaining a toy vehicle to one side of a support sheet by a retainer located on an opposite side of the support sheet from the toy vehicle. Two embodiments are disclosed, a first embodiment where the retainer operates by being deformed when passing through an opening in the support sheet and connecting to a more rigid portion of the toy vehicle where the retainer passes into a recess, and the second embodiment where a portion of the toy vehicle passes through the opening in the sheet and deforms to allow engagement with a more rigid retainer. A second patent listing Wilford as inventor, U.S. Pat. No. 4,261,466, issued one year later and had the same title as his earlier patent, “Retention Of Articles On A Sheet”. This patent also purports to disclose a device for retaining a toy vehicle to one side of a support sheet having a specially configured opening. A retainer is located on an opposite side of the support sheet from the toy vehicle. The toy vehicle includes a stand with two oppositely directed L-shaped feet that extend through the sheet opening and through the retainer. To restrain the toy vehicle in place, the retainer is rotated so as to misalign the retainer and the opening and thereby capture the feet of the stand.

In 1995, U.S. Pat. No. 5,411,138, listing Klawiter as inventor, issued for an invention entitled “Packaging For A Toy” and purports to disclose a key device for packaging a toy vehicle. The toy vehicle includes a slot, and a box in which the toy vehicle is packaged includes a bottom wall with an opening. The key device, including a base, a shaft and oppositely disposed fingers at an end of the shaft, is also disclosed. The key, dimensioned to allow passage, is inserted through the opening in the box and through the slot of the toy vehicle. Lock is achieved by rotating the key about 90° to cause a misalignment between the fingers and a bottom of the toy vehicle at one end of the key, and an overlap of a base with the bottom wall of the box at the other end of the key. A 1999, U.S. Pat. No. 5,896,991, listing Hippely et al., as inventors, issued for a “Blister Card Package For Holding And Displaying Small Items” and purports to disclose a card backing with an extending rigid support sheet having a plurality of upwardly extending retainers with engagement slots for supporting a toy vehicle.

A more recent, U.S. Pat. No. 7,296,679, listing Lam as inventor, issued in 2007 for a “Multi-Purpose Fixing Insert For Toy Containers And Method Of Packaging” and purports to disclose a box with a keyhole, a toy vehicle also with a keyhole, a key having a knob, a stem and extending fingers, and a separate key holder having alignment pegs and a key receiving slot. In operation, the key is inserted through the keyhole of the box and the keyhole of the toy vehicle. Rotating the key misaligns the fingers with the toy wall around the keyhole and locks the toy vehicle relative to the box. The key holder is then inserted in special pegs formed on the box and receives the key knob in the holder slot to prevent the key from further rotation. Lastly, a U.S. patent application published in 2004, No. 2004/0040349, listing Guttadauro et al., as inventors for a “System, Apparatus, And Method For Anti-Theft Protection of Information Storage Media” purports to disclose a locking device that includes a hub and a post. The post includes a base, a stem and a head, the head having tapered extending arms. The hub includes upper and lower plates that are fastened together to capture a lock mechanism. The lock mechanism includes spring loaded slide members that move out of the way of the post arms when the post engages the hub and then snap closed when the arms have passed the lock mechanism. Openings in the hub are formed to receive a release device that slides the spring loaded lock members in a reverse direction allowing the post to be removed from the hub.

These disclosures are interesting, but none disclose a simply constructed, inexpensive, and yet robust apparatus that allows a product to be connected to it package or container, to maintain that connection during shipment, to allow retail display of the product in the package in a pleasing arrangement, and thereafter, to allow easy separation of the product from the package by a consumer.

### SUMMARY OF THE INVENTION

In accordance with the present invention, an advantageous apparatus is provided that enhances packaging of products so that the product may go from assembly to retail shelve space without further labor cost relating to packaging. The inventive apparatus includes inexpensive parts, is easy to use, connects quickly, involves low labor cost, is structurally robust and disconnects easily and quickly. The present invention also provides an advantageous method for connecting a product to its package or container. A preferred embodiment described below includes a rotatable key with an enlarged base where the base has an opening. The key includes a post extending away from the base and oppositely disposed protrusions, at about 90°, extending from the post and spaced from the base. A second element is a strip of material to engage the base of the key or a panel having integrated strips in the form of a hole to receive the key post and protrusions, and two oppositely disposed strip tabs adjacent to or flanking the hole for receipt through the key base opening.

Briefly summarized, the invention includes a fastening apparatus for connecting a product to its package having a rotatable key with a base having an opening, a post extending away from the base, and a protrusion spaced from the base and extending away from the post, and a separate strip or strips incorporated in a panel of generally rigid material, the panel strips each having a hole to receive the post and the protrusion of the key and two oppositely disposed strip tabs adjacent the hole. The separate strip or the incorporated strips fit within the opening in the key base. The post and protrusion are sized to pass through a hole in the panel strip, a hole in the package and an opening in the product when the post and protrusion are in a first position, and upon rotation of the key to another position the protrusion misaligns with the product to obstruct passage of the protrusion away from the product. The strip or the strip tabs are inserted into the base opening to prevent inadvertent rotation of the key.

The current invention also relates to a method for connecting a product to its package including the steps of bending a portion of a base of a key, the key base having an opening and the key also including a post and a protrusion spaced from the base and extending away from the post, inserting the key post into a hole in the package and an opening in the product, rotating the key to misalign the protrusion and the opening in the product to obstruct removal of the key from the product, and inserting a strip or strip tabs into the opening in the base to restrain the key from inadvertent rotation.

### BRIEF DESCRIPTION OF THE DRAWINGS

For the purpose of facilitating an understanding of the invention, the accompanying drawings and description illustrate preferred embodiments thereof, from which the invention, its structures, its construction and operation, its processes, and many related advantages may be readily understood and appreciated.

FIG. 1 is a side isometric view of a toy dinosaur product connected to its package.

FIG. 2 is a rear isometric view of the toy dinosaur's left foot supported on a bottom wall of the package.

FIG. 3 is a front isometric view of the toy dinosaur's left and right feet on the bottom wall of the package.

FIG. 4 is a downward looking isometric view of the bottom wall of the package shown in FIGS. 1-3, with the toy dinosaur removed, and illustrating three fastener keys.

FIG. 5 is a bottom plan view of the right foot of the toy dinosaur with two keys connected to the foot for illustrative purposes and without showing the bottom wall of the package.

FIG. 6 is a top plan view of the foot of the toy dinosaur illustrating two key openings.

FIG. 7 is an upward looking isometric view of a key of a fastening apparatus.

FIG. 8 is a downward looking isometric view of the key illustrated in FIG. 7.

FIG. 9 is a bottom plan view of the key illustrated in FIGS. 7 and 8.

FIG. 10 is an elevation view of the key illustrated in FIGS. 7-9.

FIG. 11 is a downward looking isometric view of the key illustrated in FIGS. 7-10, showing outer ring portions in a generally perpendicular or handle position.

FIG. 12 is a side elevation view of the key illustrated in FIG. 11.

FIG. 13 is a bottom isometric view of two keys restrained by a strip.

FIG. 14 is a plan view of a panel with three keys and three strips.

FIG. 15 is an exaggerated sectional view taken along line 15-15 of FIG. 14.

FIG. 16 is an exaggerated sectional view taken along line 16-16 of FIG. 14.

FIG. 17 is a plan view of a key inserted into a product and illustrating detents.

FIG. 18 is a plan view of the key illustrated in FIG. 17, after rotation.

FIG. 19 is a flow diagram of the inventive method disclosed herein.

### DETAILED DESCRIPTION OF THE EMBODIMENTS

The following description is provided to enable those skilled in the art to make and use the described embodiments set forth in the best mode contemplated for carrying out the invention. Various modifications, equivalents, variations, and alternatives, some of which are set forth below, however, will be readily apparent to those skilled in the art. Any and all such modifications, variations, equivalents, and alternatives are intended to fall within the spirit and scope of the present invention.

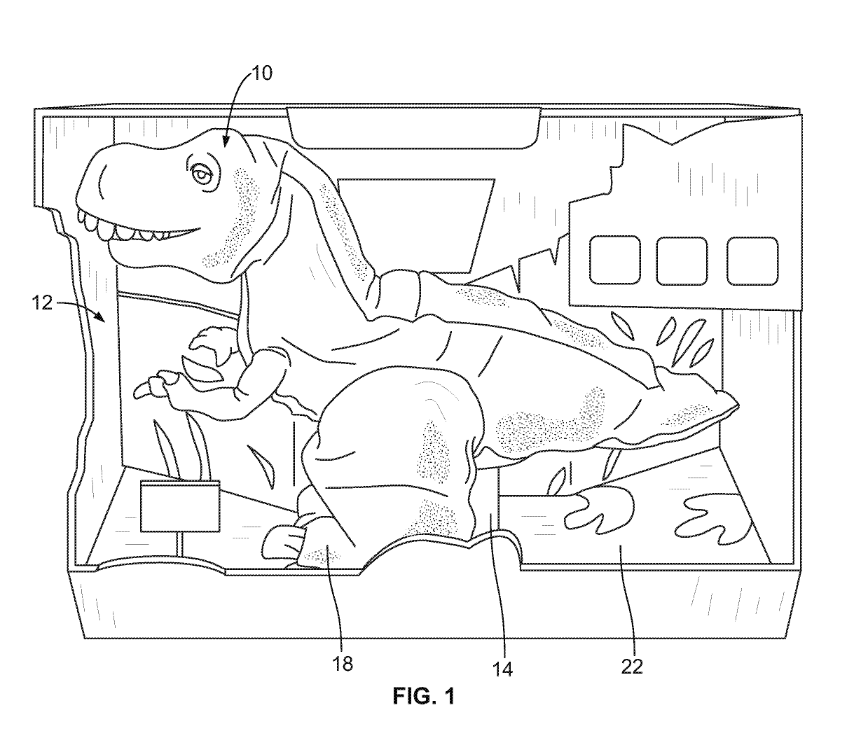

Referring now to FIGS. 1-3, there is illustrated a product and its package or container of the kind for which the inventive fastening apparatus may be used to easily and quickly connect and later disconnect the product and the package. The product may be a toy animal in the form of a plush dinosaur 10, as shown mounted in a display package 12 having appropriate printed graphics, as well as trademark logos, advertising, instructions and other commonly found information on toy packages. Typically, the product and package will have a clear plastic covering, however, the covering has been removed for clarity. Also typically, after manufacture of the toy, it is packaged at a factory or an assembly location so that the product/package combination is ready for shipment to retailers. Usually, a number of packaged products are placed in a plain corrugated shipping box (not shown) for long distance shipment, for example, from China to the United States. It is very desirable and an object of the invention that each product be displayed at the retail level while still mounted in the same attractive package in which the product left the packaging location so as to minimize labor and packaging costs. Of course, other kinds of toys and other kinds of products may be packaged using the inventive locking apparatus to be described below.

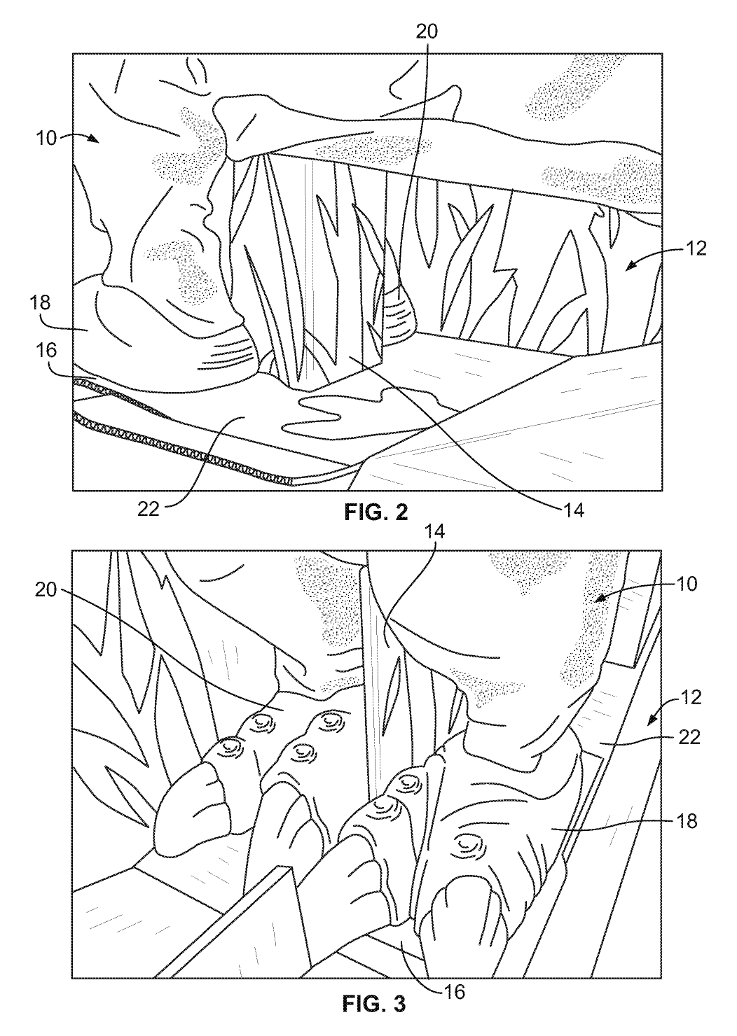

To achieve the desired results, the product should be maintained in a restrained attitude relative to the package so that aesthetics are assured, that neither the product nor the package are damaged during shipment, and that the package with the product, when removed from the shipping box, are in condition to be directly mounted to or on retail store shelves. There should be no need to repackage the product or to remove the product from the package for retail display. As may be seen in FIGS. 1-4, the desired objects are achieved by having the toy dinosaur 10 correctly positioned and supported by corrugated inserts 14, 16. To prevent movement of the toy relative to the package, fastening apparatuses connect the dinosaur's feet 18, 20 to a bottom wall 22 of the package 12. In FIG. 4, there is illustrated a portion of the package 12 and the bottom wall 22 with the toy dinosaur removed. Three fastening apparatuses 24, 26, 28 are shown, one fastening apparatus 24 for the left foot 18 of the toy dinosaur and two fastening apparatuses 26, 28 for the right foot 20 of the toy dinosaur.

In the alternative, a product may be structured to connect to a package in locations other than feet or other lower structures. For example, if the product is a toy vehicle, a fastening apparatus may be connected to a chassis or a roof of the toy vehicle. Also, the fastening apparatus may be placed through sidewalls of a package or container instead of, or in addition to, a bottom wall. By connecting the toy dinosaur to the bottom wall 22 of the package 12 the fastening apparatuses are typically not viewable by a consumer until the package is opened to remove and separate the product from the package.

Referring now to FIGS. 5 and 6, the right dinosaur foot 20 is formed of a sufficiently strong and/or rigid plastic to maintain a connection with the fastening apparatuses 26, 28. The bottom of the foot 20 is illustrated in FIG. 5, with two fastening apparatus 26 and 28 mounted in place. This arrangement is shown for instructive purposes only because in actual practice at least the bottom wall of a package, such as the bottom wall 22, would be positioned between the fastening apparatus and the dinosaur foot as will be explained in more detail below. As described herein a key is inserted through the package and into the product, the key is rotated to cause an abutment of the protrusions with the product to fasten the product and package together. The strip is then inserted to prevent inadvertent rotation of the key. After purchase, a consumer may easily and quickly remove the strip, rotate the key and remove it from the product and the package to enable the product to be separated from the package, and the package and the key to be disposed. Multiple keys are used with multiple strips incorporated in a stiff paper panel.

In FIG. 6, the top of the foot 20 is illustrated having two openings or keyholes 40, 42 each shaped with a central circular opening 44 and oppositely disposed wing openings 46, 48. Holes 50, 52, 54, FIG. 4, in the bottom wall 22 are each sized to allow passage of part of a key of the fastening apparatus, but not all of it. The holes 52, 54 in the package bottom wall 22 are designed to align with the keyholes 40, 42, FIG. 6, in the right foot 20 of the toy dinosaur. The hole 50 in the bottom wall 22 is designed to align with a keyhole (not shown) formed in the left foot 18 of the toy dinosaur. The keyhole in the left foot of the toy dinosaur is identical to one of the keyholes in the toy dinosaur's right foot. The openings or keyholes in the feet of the toy dinosaur are constructed for each to allow a key to be received when the key is in a first position and to misalign and trap the key when the key is rotated approximately 90°.

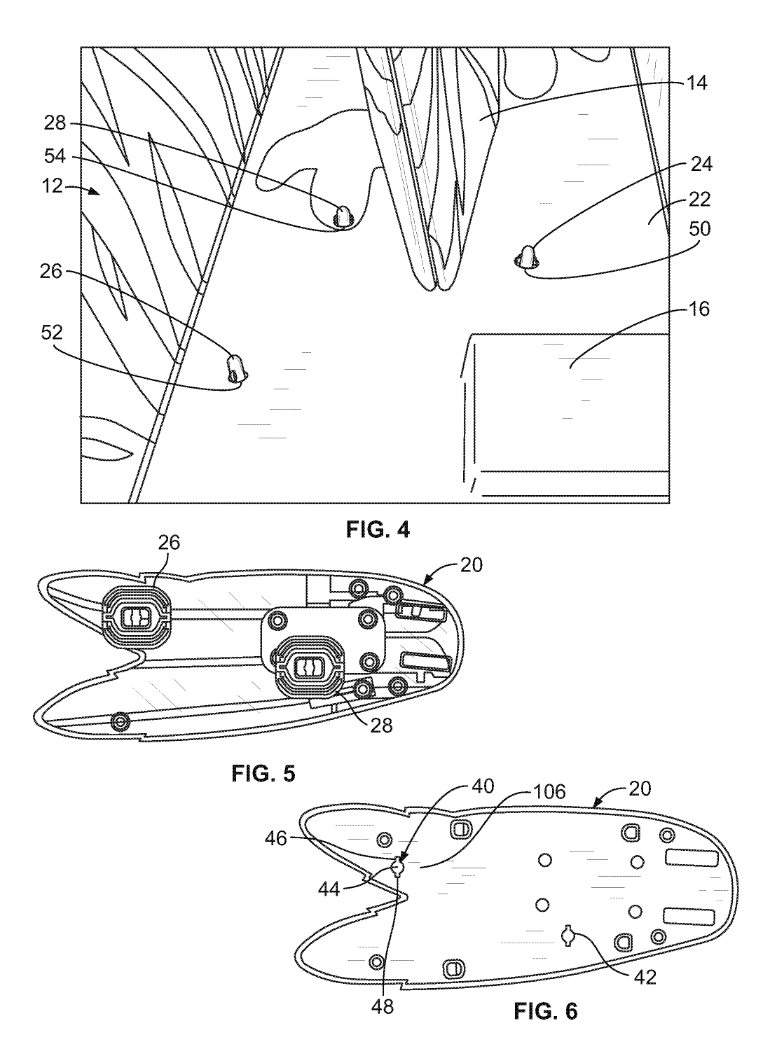

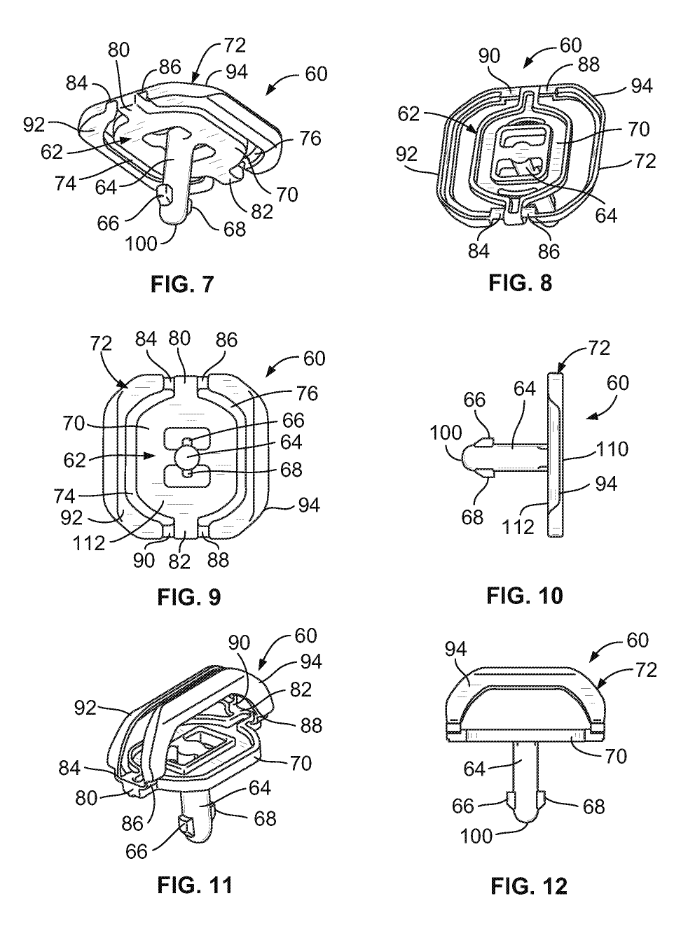

Referring now to FIGS. 7-12, the inventive fastening apparatus for connecting a product to its package includes a key or connector 60, the key 60 having a base 62, a post 64 and protrusions 66, 68. The key base 62 includes an inner structure or pad 70, an outer structure or ring 72, spaces or openings 74, 76 between the inner pad 70 and the outer ring 72, and a pair of bridges 80, 82 connecting the outer ring 72 to the inner pad 70. To each side of the bridges 80, 82 are living hinges 84, 86, 88, 90. Living hinges are very thin portions of the same material as the remaining structure that exists on both sides of the hinge. This arrangement allows relative pivoting of the structure portions to each side of the hinge. It is preferable that the key here is formed of a synthetic resin by an injection molding operation. Such an operation maintains costs to a minimum and allows the key to be disposable.

Left outer ring portion 92 of the outer ring 72 is connected to the bridges 80, 82 by the living hinges 84, 90 and right outer ring portion 94 is connected to the bridges 80,82 by the living hinges 86, 88, such that each of the outer ring portions 92, 94 is allowed to pivot or rotate from a first position where the outer ring portions are generally aligned in a planar relationship with the inner pad 70, as shown in FIGS. 7, 8, 9 and 10, to a second position where the outer ring portions 92, 94 are generally perpendicular to the inner pad 70, as shown in FIGS. 11 and 12, such that the ring portions may act as a handle for rotating the key. The positions of the outer ring portions 90, 92, shown in FIG. 11, define the term “generally perpendicular” as used here.

The key post 64 extends away from the key base 62, and toward an extended end portion 100 of the post 64 where the oppositely disposed protrusions 66, 68 extend generally perpendicular from the post, as shown. As mentioned, the post 64 and the protrusions 66, 68 are sized to fit through a hole in a package and an opening in a product, such as the hole 52, FIG. 4, in the bottom wall 22 of the package 12, and the keyhole 40, FIG. 6, in the foot 20 of the toy dinosaur, and when the post 64 and the protrusions 66, 68 are rotated a misalignment and abutment occurs between the protrusions and a local portion of the product, such as a wall 106, FIG. 6, surrounding the keyhole 40, so as to capture the protrusions and thereby capture the key. The outer ring 72 is connected to the bridges 80, 82 so as to encircle the inner pad 70 and form the openings or spaces 74, 76 located between the inner pad 70 and the outer ring 72. The inner pad 70 and the outer ring 72 of the key base 62 have first and second surfaces 110, 112. The first surface 110 is a lower surface when the key is in use in the bottom wall 22 of the package 12, as shown in FIG. 14, for example, and the second surface 112 is the upper surface. In the alternative, the key may be inserted from a side or even from the top of the package, if convenient so as change what is “lower” and “upper”.

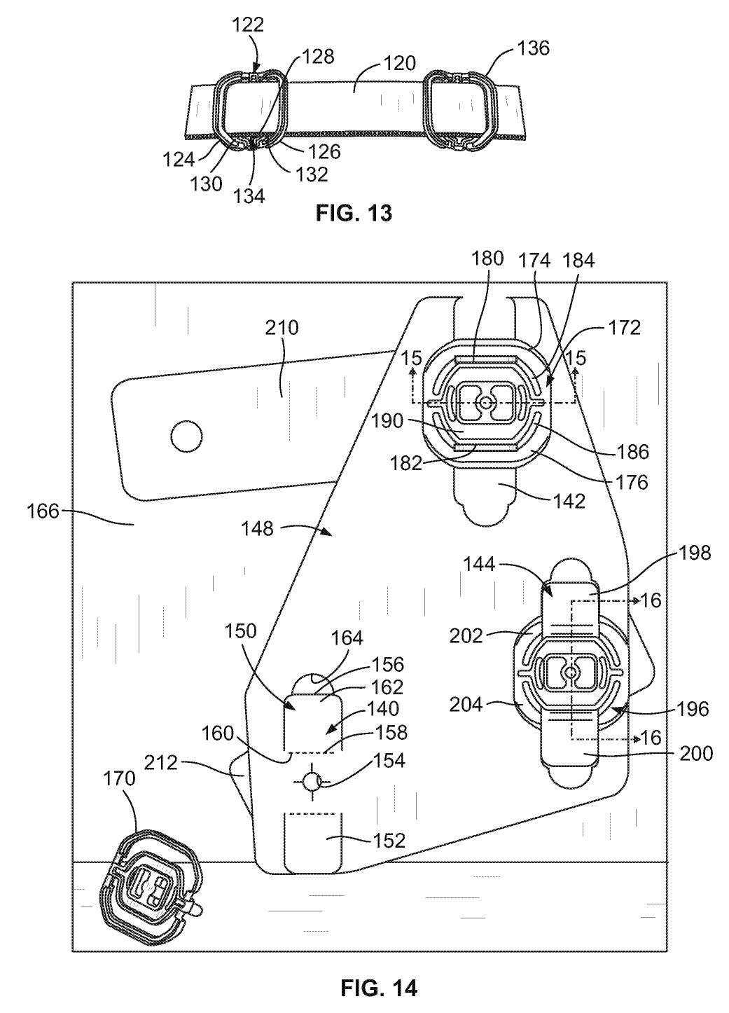

The inventive fastening apparatus includes in one embodiment a single strip of material, such as a strip of stiff paper 120, FIG. 13. After a key, such as the key 122, is inserted through a package and into a product and then rotated to lock, and before the outer ring portions, such as the ring portions 124, 126, are pivoted back from their generally perpendicular positions, the strip 120 is inserted into the openings in the key base, such as the openings 130,132 in the base 134 of the key 122. Thereafter, the outer ring portions 124, 126 are returned to their general alignment with an inner pad 128 to restrain the key in place, provided that the strip is restrained in some way such as by tape or a piece of the package or another key. If two keys are used as shown in FIG. 13, the single strip 120 may extend through both keys, such as the keys 122, 136. This ensures that neither key inadvertently rotates to an unlocked position without the strip 120 first being removed, and the strip 120 does not need another structure to prevent the strip 120 from inadvertently rotating because when the same strip is used for two or more keys, the keys themselves restrain the strip from rotation and the friction between the strip and the keys prevents the strip from dislodging on its own. As viewed in FIG. 13, which is a bottom view, the strip 120 covers the bottom surfaces of the inner pads of the keys 122, 136 and contacts the upper surfaces of the ring portions.

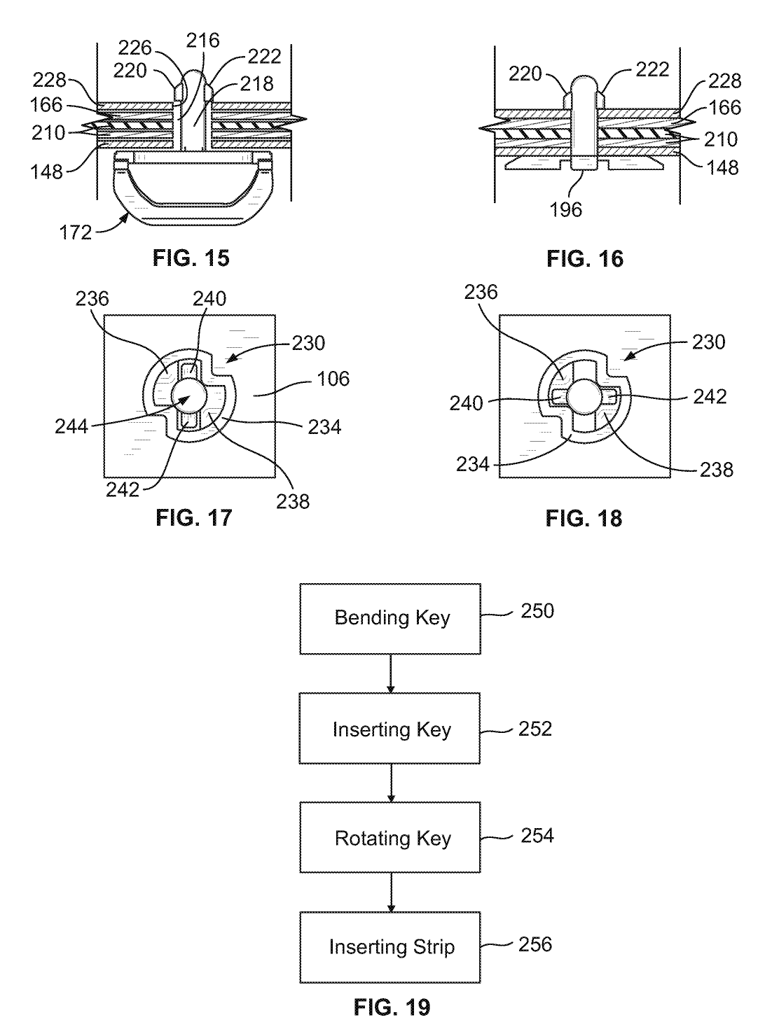

Another embodiment of the strip is shown in FIG. 14, where three strips 140, 142, 144 are incorporated in an enlarged sheet or panel 148 formed of stiff or heavy paper. The three strips 140, 142, 144 are arranged in a triangular formation on the triangularly shaped panel 148. Each strip, such as the strip 140, is formed by a pair of oppositely facing strip tabs, such as the pair of tabs 150, 152 flanking a hole 154, sized to allow passage of the post and the protrusions of a key. The hole 154 in the panel 148 may be the same size as the holes in a package wall, such as the holes 50, 52, 54 in the bottom wall 22, FIG. 4, to allow the post and the protrusions of the key to pass through, such as the post 64 and the protrusions 66, 68 of the key 60, FIGS. 7-12, but be too small to allow the key base 62 to pass. Each of the strip tabs 150, 152 includes a pivotal finger, such as the finger 156, having a base 158 integral with the panel 148 at one end 160 and a free end 162 adjacent a convenience opening 164 so that an assembly worker is able to easy engage the free end 162 and pivot the strip tab 150 for engaging the strip tab with a key. The paper panel is placed on the under or opposite side of a package wall 166 from a product in the package, as will be shown in more detail in reference to FIGS. 15 and 16.

To fasten or lock a product to its package using the panel 148, each key has its outer ring portions, such as the outer ring portions 92, 94, FIGS. 11 and 12, pivoted about 90°, such as shown. The key post and protrusions, such as the post 64 and protrusions 66, 68 are inserted into the panel 148, the bottom wall 166 of the package and into the product. Thereafter, the key is rotated about 90° using the outer ring portions as handles to misalign the protrusions relative to a keyhole in the product. For example, in FIG. 6, a post and protrusion passing through the central opening 44 and the wing openings 46, 48 will abut the wall 106 after the post is rotated about 90°. With the outer ring portions in lifted positions, opposing strip tabs that flank the hole through which the key is inserted, are themselves inserted into the openings between the inner pad and outer ring of each key, and the outer ring portions of each key are then lowered. For example, the strip tabs are inserted into the openings 74, 76 of the key 60. In this fashion the key fastens or locks the product to the package, and the key cannot be accidentally rotated so as to inadvertently unlock. Because the strip tabs are integral with the panel, they are fixed in place. A panel with a single hole and a single pair of tabs may need further restraints, but a panel with two or more holes and two or more pairs of tabs will be self-restrained because the panel will be anchored by the two or more keys.

The process of connecting a key through the panel is illustrated in FIG. 14, where the strip 140 is shown in a ready condition to receive a key 170 shown separated from the panel. The strip 142 is shown in the process of connecting to a second key 172. With the outer ring portions 174, 176 of the second key 172 in lifted positions, opposing strip tabs 180, 182 that flank the hole of the strip 142 through which the key post and protrusions of the key 172 are inserted, are themselves inserted into openings 184, 186 between inner structure 190 and the outer ring portions 174, 176 of the second key 172. The strip 144 is shown completely connected to a third key 196 with each strip tab 198, 200 of the strip 144 in lowered positions along with the lowered outer ring portions 202, 204 of the third key 196.

In the alternative, the panel 148 may have another geometric shape, likely to be a function of the product to be secured, and have more or less holes and corresponding pairs of strip tabs, and may be made of a material other than stiff or heavy paper, such as a sheet of plastic or a piece of corrugated. Also in the alternative, another strip that may be incorporated in a panel, such as by stamping, may include a hole and a single strip tab adjacent the hole in the panel, the strip tab being bendable to engage an opening in a base of a key to prevent the key's rotation.

In addition to the panel 148, corrugated supports 210, 212, FIG. 14, may be used as reinforcements between the package wall 166, and the panel 148. The corrugated support 210, folded over as shown in FIGS. 14-16, so as to provide a double layer, also has a hole 216 sized to allow passage of a post 218 and protrusions 220, 222 of the second key 172, FIG. 15. The corrugated support strengthens the region of the package through which the key passes and also provides a compressible material to help keep the key in a secure connection with a product. The key passes through the panel 148, the corrugated support 210, twice, then the package wall 166, and a keyhole 226 in a product 228. To secure the connection, the layers through which the key passes are squeezed so that when the key is rotated about 90° from the position shown in FIG. 15, to the position shown in FIG. 16, the corrugated support creates a force biasing the abutting protrusions 220, 222 against the product 228. This arrangement provides added friction to keep the key from inadvertently rotating. It is to be noted that FIGS. 15 and 16, illustrate the layers of the panel, the support, the package, and the product in an exaggerated fashion.

In operation of a key and a strip to fasten or lock a product to its package, the product and package are formed with aligning holes, keyholes or openings. The product is placed relative to the package so as to align the keyholes in the product with the holes of the package. A corrugated support may be placed adjacent the hole in a package wall on the side of the wall opposite of that contacting the product, and the holes of the doubled over corrugated support and the package wall are aligned. A panel is placed over the corrugated support, aligning the holes of the panel with the holes of the corrugated support. To lock a product to its package, a key is positioned to have its post and protrusions pass through the aligned holes in the panel, the corrugated support, the package wall, and into the keyhole of the product. This operation is illustrated in FIGS. 14-16. For convenience during this manipulation, the outer ring portions of the key are pivoted about 90° as shown in FIGS. 11, 12 and 14.

After the key post and protrusions are inserted into the product, the corrugated support may be squeezed slightly and the key is rotated about 90° using the outer ring portions as handles to misalign the protrusions relative to the keyhole in the product and thereby create an abutting engagement between the protrusions and the product at one end of the key, and the key base and the panel at the other end as shown in FIG. 16. With the outer ring portions in lifted positions, a strip or opposing strip tabs that flank the panel hole through which the key is inserted, are themselves passed through the openings between the inner pad and the outer ring portions of the key, and the outer ring portions and the strip tabs are then lowered. Because the strip tabs are integral with the paper panel, they are fixed in place. In this fashion, the key locks the product to the package, and the key cannot be accidentally or inadvertently rotated so as to unlock or disconnect the product from its package.

After purchase however, a consumer may easily disconnect or unlock a key by simply lifting the outer ring portions sufficiently to pull out the strip or the strip tabs, rotate the key about 90° to disengage the protrusions from the product, and pull the key away from the package. The key may be disposed along with the package because both are relatively inexpensive.

In still another embodiment shown in FIGS. 17 and 18, the dinosaur feet may be structured with keyholes, such as keyhole 230 surrounded by a curved wall 234 and bumps or detents 236, 238, such that protrusions 240, 242 of a key 244 becomes captured by the foot wall 106, FIG. 6, after the key is inserted (see FIG. 17), and then rotated (see FIG. 18). The openings of the structured keyholes in the product are thus at least partially surrounded by the curved wall and accordingly define one or more bumps at the surrounding curved wall. In this embodiment there is the added restraint of the detents to be overcome for the key to be rotated. The key protrusions 240, 242 must pass over the detents 236, 238 when the key is rotating back to the position shown in FIG. 17.

The invention here also includes a method, as shown in FIG. 19, for connecting a product to its package including the step 250 of bending a portion of a key base where the key base includes an opening, and the key also includes a post and a protrusion, the protrusion being spaced from the base and extending away from the post, the step 252 of inserting the key post into a hole in the package and an opening in the product, the step 254 of rotating the key to misalign the protrusion and the opening in the product so as to obstruct removal of the key from the product, and the step 256 of inserting a strip into the opening in the base. The method may also include the step of placing a panel between the key base and the package where the panel includes a hole and oppositely disposed strip tabs, the step of inserting the key post into the hole in the panel before inserting the key post into the package and the product, and the step of inserting the two strip tabs into the opening in the base. Lastly, the method may include the step of placing a reinforcing corrugated support between the panel and the package where the support includes a hole, and the step of inserting the key post into the hole of the support after inserting the key post into the panel and before inserting the key post into the hole of the package.

The important features of the inventive locking apparatus, its simple construction, its ease of use, and its low expense so as to be disposable while still being sufficiently robust for connecting a product to its package during shipment and as well as during retail display, have been fully shown and described in detail above.

From the foregoing, it can be seen that there has been provided features for an improved locking apparatus and a method for connecting a product to its package. While specific embodiments of the present invention has been shown and described in detail, and alternatives have been suggested, it will be obvious to those skilled in the art that changes and modifications may be made without departing from the invention in its broader aspects. Therefore, the aim here is to cover all such changes, modifications and alternatives as fall within the true spirit and scope of the invention as expressed in the appended claims. The matters set forth in the foregoing detail description and accompanying drawings are offered by way of illustrations only and not as claim limitations. The actual scope of the invention is to be defined by the subsequent claims when viewed in their proper perspective based on prior art.

What is claimed is:

1. An apparatus for fastening a product to packaging comprising:
the product;
a package defining at least one hole therein;
a rotatable key having a post and a protrusion thereon, wherein the post and protrusion are sized to pass through the at least one hole in the package and through an opening in the product when the post and protrusion are in a first position, and upon rotation of the key to another position the protrusion misaligns with the opening in the product to form an abutting relationship with the product;
a strip of material for engaging the rotatable key to prevent rotation of the rotatable key; and
said rotatable key further comprising a base which defines at least one base opening of said rotatable key, wherein said strip of material removably engages said rotatable key through said at least one base opening to prevent rotation of said rotatable key.

2. The apparatus of claim 1, wherein:
the key base includes an inner structure and an outer structure with the at least one base opening being located between the inner structure and the outer structure to enable the strip to pass through the at least one base opening.

3. The apparatus of claim 2, wherein:
the inner structure supports the post and the outer structure; and
the outer structure is movable between first and second positions.

4. The apparatus of claim 2, wherein:
the outer structure is connected to the inner structure with a living hinge.

5. The apparatus of claim 2, wherein:
the outer structure includes two portions which are movable between first and second positions, wherein the first position is generally in planar alignment with the inner structure and the second position is generally perpendicular with the inner structure.

6. The apparatus of claim 2, wherein:
the inner structure and the outer structure have first and second surfaces; and
the strip is located to cover the first surface of the inner structure and the second surface of the outer structure.

7. The apparatus of claim 3, wherein:
the outer structure is connected to the inner structure with a living hinge.

8. The apparatus of claim 7, wherein:
the outer structure includes two portions which are movable between first and second positions, wherein the first position is generally in planar alignment with the inner structure and the second position is generally perpendicular with the inner structure.

9. The apparatus of claim 6, wherein:
the outer structure includes two portions which are movable between first and second positions, wherein the first position is generally in planar alignment with the inner structure and the second position is generally perpendicular with the inner structure.

10. The apparatus of claim 1, wherein the opening in the product is at least partially surrounded by a curved wall of the product which further comprises one or more bumps at the surrounding curved wall.

11. The apparatus of claim 10, wherein:
the post and protrusion are sized to pass said one or more bumps of the curved wall through the opening in the product when the post and protrusion are in the first position, and upon the rotation of the key the protrusion abuts said one or more bumps at the surrounding curved wall of the product.

12. An apparatus for fastening a product with packaging comprising:
the product;
a package defining at least one hole therein;
a rotatable key having a post and a protrusion thereon, wherein the post and protrusion are sized to pass through the at least one hole in the package and through an opening in the product when the post and protrusion are in a first position, and upon rotation of the key to another position the protrusion misaligns with the opening in the product to form an abutting relationship with the product;
a panel;
a strip comprising a strip tab and a hole formed in the panel, the hole in the panel for receiving the post and the protrusion of said rotatable key, and the strip tab located adjacent to the hole in the panel for preventing rotation of the rotatable key; and
said rotatable key further comprising a base which defines at least one base opening of said rotatable key, wherein the strip tab removably engages the rotatable key through said at least one base opening to prevent rotation of the rotatable key.

13. The apparatus of claim 12, wherein:
the key base includes an inner structure and an outer structure; and
the at least one opening is located between the inner structure and the outer structure to enable the strip tab to pass through the at least one opening.

14. The apparatus of claim 13, wherein
the inner structure supports the post and the outer structure; and
the outer structure is movable between first and second positions.

15. The apparatus of claim 13, wherein:
the outer structure is connected to the inner structure by two pairs of living hinges.

16. The apparatus of claim 13, wherein:
the outer structure includes two opposing portions which are movable between first and second positions, wherein the first position is generally in planar alignment with the inner structure, and the second position is generally perpendicular with the inner structure.

17. The apparatus of claim 14, wherein:
the outer structure includes two opposing portions which are each connected to the inner structure by a pair of living hinges; and
the two opposing portions are movable between first and second positions, wherein the first position is generally in planar alignment with the inner structure, and the second position is generally perpendicular with the inner structure.

18. A method for connecting a product to packaging comprising the steps of:
bending a portion of a key base, the key including a post and a protrusion, and the key base including an opening;
inserting the post and the protrusion through a hole in a wall of a package and into an opening in a product;
rotating the key to misalign the protrusion and the product to obstruct removal of the key from the product; and
inserting a strip through the opening in the key base to prevent rotation of the key.

19. The method of claim 18, including the steps of:
placing a panel between the key base and the package, the panel including a bendable strip tab and a hole adjacent the bendable strip tab;
inserting the post and protrusion through the hole of the panel before inserting the post and protrusion through the wall of the package and through the opening in the product; and
inserting the bendable strip tab through the opening in the key base.

20. The method of claim 19, including the steps of:
placing a reinforcing support between the panel and the package, the support having a hole; and
inserting the key post and protrusion through the hole of the reinforcing support after inserting the key post and protrusion through the hole in the panel and before inserting the key post and protrusion through the hole in the wall of the package.
